(19) United States
(12) Patent Application Publication
(10) Pub. No.: US 2008/0281999 A1
(43) Pub. Date: Nov. 13, 2008

(54) ELECTRONIC SYSTEM WITH DIRECT MEMORY ACCESS AND METHOD THEREOF

(75) Inventors: Hsin-Yu Kang, Taipei City (TW); Cheng-Ting Wu, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/744,961

(22) Filed: May 7, 2007

(51) Int. Cl. G06F 13/28

(52) U.S. Cl. 710/23

(57) ABSTRACT

In an electronic system, a DMA circuit is supplied with a device selection signal that indicates a processor is accessing or going to access a memory. If the DMA circuit finds that the processor is not accessing or not going to access the memory, the DMA circuit starts its DMA operations. Once the DMA circuit finds that the processor is going to access the memory, the DMA circuit stops its DMA operation and return the use of the memory to the processor.

### BACKGROUND OF THE INVENTION

1. Field of the Invention

The invention relates to an electronic system and a design method thereof and more particularly relates to an electronic system with DMA and a method thereof.

2. Description of the Related Art

Direct Memory Access (DMA) is an important feature of modern electronic systems, as it allows devices to transfer data without subjecting a master processor to a heavy overhead. In computers, such master processor is the central processing unit (CPU). In other embedded systems, such master processor may refer to a controlling processor or a digital signal processor.

Without DMA, master processors would have to copy each piece of data from the source to the destination. When moving data between memory devices, the master processors are not able to perform other instructions. With DMA, total performance of an electronic system is improved because a master processor is available to execute other instructions while a DMA circuit is responsible of moving data between one or more memory devices.

Typically, a DMA circuit receives a DMA command from a master processor and executes the DMA command by accessing one or more memories. To prevent access conflict of a memory bus, “cycle stealing” is usually adopted. In “cycle stealing”, the accessibility of a processor to a memory device is temporarily disabled after a handshaking protocol. That is, a DMA circuit sends a request to a master processor when trying to perform a DMA operation. After receiving an acknowledge response from the processor, the DMA circuit starts performing the DMA operation.

The use of “cycle stealing”, however, has certain inefficiency due to corresponding overhead. In embedded system for real time application, such waste is particularly significant. In modern electronic system designs, efficiency means less cost, less power consumption and stronger competition of a product.

### SUMMARY OF THE INVENTION

A preferred embodiment is an electronic system with direct memory access (DMA) capability. The electronic system includes a memory device, a processor and a DMA device. When the processor accesses or is going to access the memory device, a device selection signal will be set, e.g. enabled. The device selection signal is also supplied to the DMA device, usually a circuit set having finite state machine circuits or combined with firmware.

The DMA device performs a direct memory access operation from a waiting queue to access the memory device when the direct memory access device finds that the processor is not accessing the memory device by detecting the device selection signal, and for pausing the direct memory access operation if the direct memory access device finds that the processor is trying to access the memory device by detecting the device selection signal. The size of the waiting queue can be set as one or more than one, depending on requirements of specific applications.

With the embodiment, the processor does not need to perform a handshaking protocol to allow the DMA device to start DMA operations. Instead, the DMA device attempts to watch the device selection signal and starts and stops DMA operation without influencing operation of the processor and increases total performance of the electronic system.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing an electronic system according to a first embodiment of the invention.

FIG. 2 is a block diagram showing an electronic system according to a second embodiment of the invention.

FIG. 3 is a flow chart showing a method of accessing a memory according to a preferred embodiment of the invention.

FIG. 4 shows a clock diagram when first prescribed data from a first memory 130 is copied to a second memory 140 according to a DMA command Da.

### DETAILED DESCRIPTION OF THE INVENTION

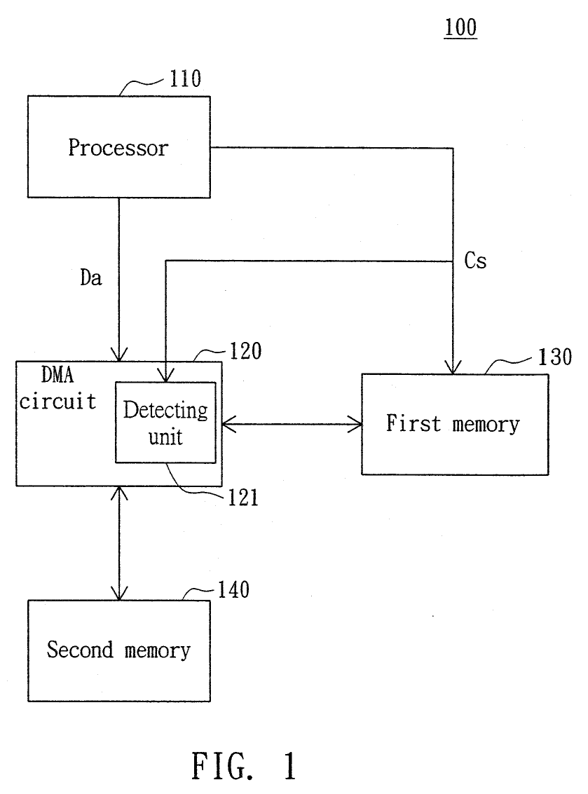

FIG. 1 is a block diagram illustrating an electronic system, which is a preferred embodiment according to the invention. The electronic system 100 includes a processor 110, a DMA (Direct Memory Access) circuit 120, a first memory 130 and a second memory 140.

The DMA circuit 120 connected to the processor 110 accesses the first memory 130 and the second memory 140. If the processor 110 is not accessing the first memory 130, the DMA circuit 120 performs a DMA operation according to a DMA command Da issued by the processor 110. In addition, the DMA circuit stops a DMA operation if the DMA circuit finds that the processor 110 is going to access the first memory 130.

For example, the DMA command Da may request first prescribed data to be copied from the first memory 130 to the second memory 140, or second prescribed data to be copied from the second memory 140 to the first memory 130.

The DMA circuit 120 includes a detection circuit 121 for detecting a device selection signal Cs, which indicates that the processor 110 is going to access and/or accessing the first memory 130. As an example, the device selection signal Cs is a signal on a signal line coupled between the processor 110 and the first memory 130. When the processor 110 is going to access the first memory 130, the processor 110 enables the device selection signal Cs. The device selection signal Cs may stay at the same status until the processor 110 finishes its access of the first memory 130. The device selection signal Cs is also supplied to the detection circuit 121. With such design, the detection circuit 121 is capable of determining whether the processor 110 is accessing or going to access the first memory 130 by detecting the device selection signal Cs. If the first memory 130 is disposed in an independent integrated circuit chip, the device selection signal Cs is a chip selection signal. Please note that the first memory 130 and the DMA circuit 120 can also be disposed in the same integrated circuit, and the device selection signal Cs refers to a signal selecting the first memory 130.

Once the DMA circuit 120 finds that the processor 110 is not accessing or going to access the first memory 130 and there is a DMA operation need to be performed, the DMA circuit 120 starts performing the DMA operation. In some cases, the DMA circuit 120 also contains a state machine circuit which controls detailed steps in executing a DMA operation or scheduling multiple DMA operations. That may include a waiting list of DMA operations to perform.

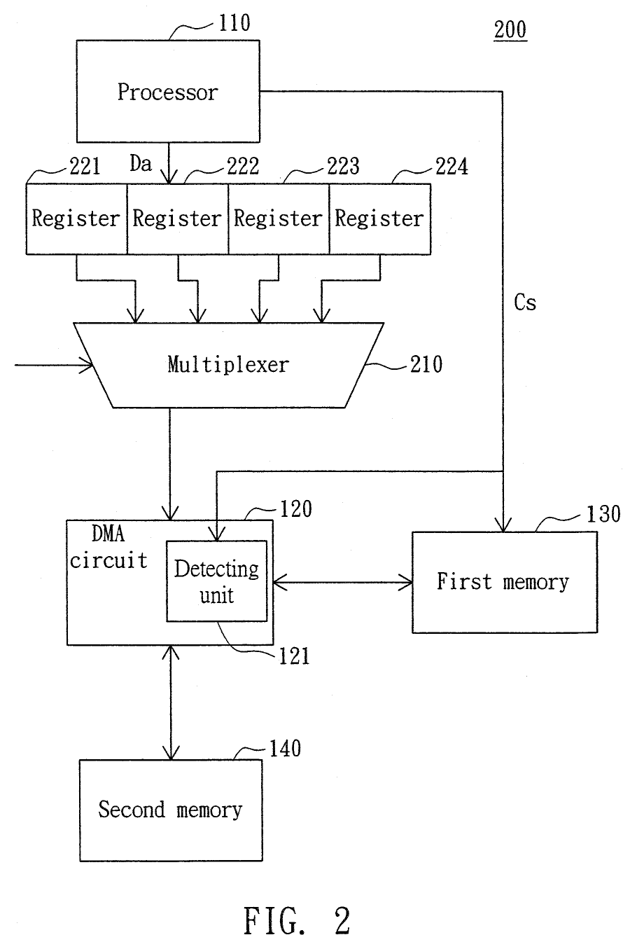

FIG. 2 is a block diagram illustrating a second embodiment according to the invention. In the second embodiment, the electronic system 200 further includes a buffer, i.e. registers 221, 222, 223 and 224, for storing a waiting queue. Please note that the buffer can also be implemented in other mechanisms known by persons skilled in the art, e.g. different data structures and/or different storage circuits if they can store one or more DMA operations to perform. The processor 110 may issue multiple DMA commands to the DMA circuit 120 at different time. DMA operations waiting to be executed are stored in the waiting queue. In this example, there is a multiplexer 210 controlled by the DMA circuit, e.g. via a state machine circuit, to fetch one or more DMA operations each time, depending on real circuits, to execute when the DMA circuit finds that the processor 110 is not accessing or going to access the first memory 130. Since the DMA circuit 120 interrupts a DMA operation once the DMA finds that the processor 110 is going to access the first memory 130, it is possible that a DMA operation needs to be divided into sections and performed separately. When such an interrupt occurs, unfinished section information is updated to an associated record and then the record is stored back to the buffer so as to ensure the DMA operation will be performed next time.

For example, a DMA operation has an associated record with contents of “Address X1, Address X2, Address Y1 and Address Y2” stored in one of the registers 221 to 224. Such record indicates a DMA operation of moving data from Address X1 to Address X2 of the first memory 130 to Address Y1 to Address Y2 of the second memory 140. If the DMA circuit 120 cannot finish the DMA operation at one time, e.g. finding that the processor 110 starts enabling the Cs, the new status, e.g. X1′, that indicates new starting address to continue next time is updated to the record.

Priority can also be designed into the second embodiment. For example, a first DMA operation of lower priority can be interrupted and stored back to the waiting queue even the processor 110 is not accessing the first memory 130. Then, a second DMA operation of higher priority can be performed first.

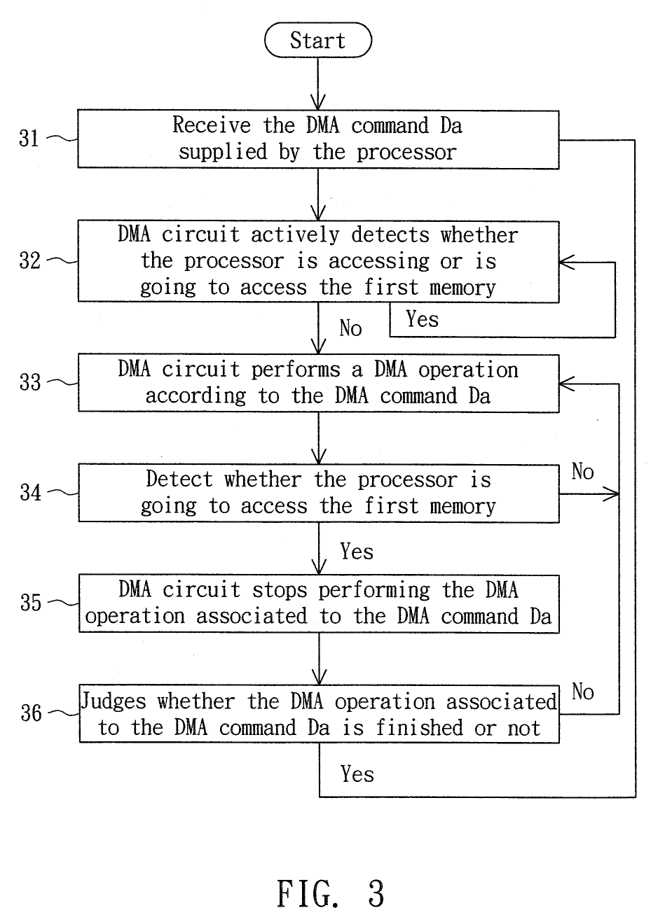

FIG. 3 is a flow chart showing a method of accessing a memory according to a preferred embodiment of the invention. Such method can be implemented into a state machine circuit and/or circuits with corresponding firmware. First, step 31 receives the DMA command Da supplied by the processor 110. Then, in step 32, the DMA circuit 120 actively detects whether the processor 110 is accessing or is going to access the first memory 130. If yes, the procedure goes to step 32. If the processor 110 is not accessing or going to access the first memory 130, the DMA circuit 120 performs a DMA operation according to the DMA command Da, as shown in step 33.

Next, step 34 continues to detect whether the processor 110 is going to access the first memory 130. If not, the procedure goes back to step 33 to continue the DMA operation. If the processor 110 is going to access the first memory 130, e.g. enabling Cs, the DMA circuit 120 stops performing the DMA operation associated to the DMA command Da, as shown in step 35. Finally, step 36 judges whether the DMA operation associated to the DMA command Da is finished or not. If yes, the procedure goes back to step 31, to wait or retrieve another DMA operation to be performed. If not, the procedure goes back to step 33.

In step 34, if the DMA command Da indicates that a large amount of data is to be moved, it is necessary to detect whether the processor 110 needs to access the first memory 130 after a portion of data have been moved in order not to influence the operation of the processor 110. This is because the processor 110 may need to use the first memory 130 when the DMA circuit 120 is performing a DMA operation.

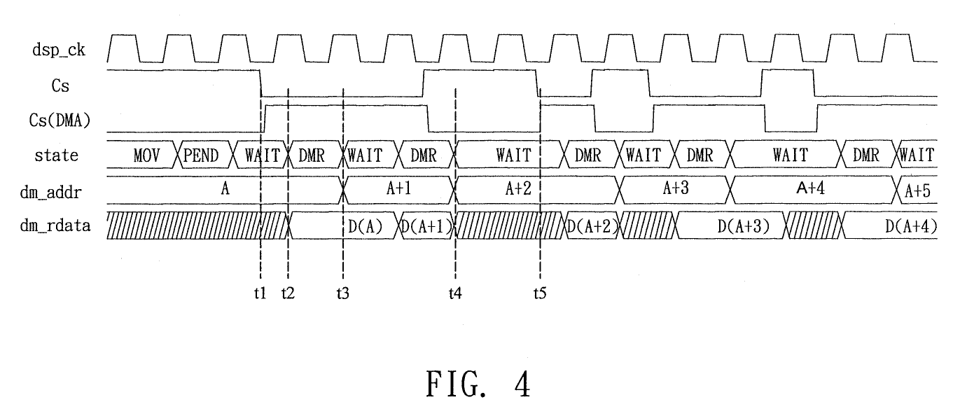

FIG. 4 shows a clock diagram when the first prescribed data from the first memory 130 is copied to the second memory 140 according to the DMA command Da. The signal dsp_ck is a clock signal of the processor 110. The signal Cs_DMA is a memory selection signal of the DMA circuit 120 for selecting the first memory 130. As shown in FIG. 4, the signal Cs_DMA and the memory selecting signal Cs are substantially inverted. The “state” is the state description of the DMA circuit 120. The signal dm_addr represents the access address of to-be-moved data. The signal dm_rdata represents the to-be-moved data.

At the beginning, the signal dm_addr has specified the access address (address A) of the to-be-moved data. At the time instant t1, the DMA circuit 120 detects that the signal Cs is disabled (i.e., the processor 110 does not use the first memory 130), and the access address of the to-be-moved data is prepared. After a cycle of time has elapsed, the DMA circuit 120 starts to access the first memory 130 at the time instant t2.

After the time instant t2, the state “state” is DMR, which represents a set of data among the to-be-moved data. The to-be-moved data is verified as D(a), as shown in the signal dm_rdata. After the time instant t3, the state is WAIT. At this time, it is again verified whether the processor 110 accesses the first memory 130, as shown in step 34. Meanwhile, the access position of the next set of data is also determined, and the access position is “A+1” as shown in the signal dm_addr.

At the time instant t4 when the data D(A+1) has been moved, the detected memory selecting signal Cs is enabled. At this time as shown in step 35, the DMA command Da has to be stopped and the state WAIT is kept, as shown in state “state”. At the time instant t5, the detected signal Cs is disabled, and the DMA circuit 120 continues to perform step 33, and the DMR state is entered.

According to the above embodiments of the invention, a DMA circuit automatically finds time to perform its DMA operations without influencing a processor. Thus, it is possible to avoid the back and forth signal transmission, which is needed when the processor controls the DMA circuit and decreases the efficiency of data movement.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic system with direct memory access capability, comprising:
a memory device;
a processor for accessing the memory device by setting a device selection signal of the memory device; and
a direct memory access device for performing a direct memory access operation from a waiting queue to access the memory device when the direct memory access device finds that the processor is not accessing the memory device by detecting the device selection signal, and for pausing the direct memory access operation if the direct memory access device finds that the processor is trying to access the memory device by detecting the device selection signal.

2. The electronic system of claim 1, wherein the memory device, the processor and the direct memory access device are disposed in an integrated circuit chip.

3. The electronic system of claim 1, wherein the processor is a digital signal processor.

4. The electronic system of claim 1, wherein the memory device is disposed in an integrated circuit chip and the device selection signal is a chip selection signal.

5. The electronic system of claim 1, wherein the direct memory access device comprises a detection circuit for receiving the device selection signal and a buffer circuit for storing the waiting queue containing a plurality of direct memory access operations issued by the processor.

6. The electronic system of claim 5, wherein the direct memory access device further comprising a state machine circuit for executing the direct memory access operation and pausing the direct memory access operation by reference to detection of the device selection signal by the detecting circuit.

7. The electronic system of claim 6, wherein the state machine circuit moves the direct memory access operation into the waiting queue when the detection circuit detects the processor is going to access the memory device by detecting the device selection signal.

8. The electronic system of claim 6, wherein the state machine moves the direct memory access operation that is not completely finished but has lower priority to the waiting queue and performs the direct memory access operation that has highest priority.

9. The electronic system of claim 1, wherein the direct memory access operation includes moving data between the memory device and another memory device.

10. The electronic system of claim 1 wherein the processor is a central processing unit (CPU).

11. A direct memory access method for accessing a memory device, comprising:
providing a processor capability of setting a device selection signal when the processor needs to access the memory device;
providing a direct memory access device capability of detecting the device selection signal;
performing a direct memory access operation when the direct memory access device finds that the processor is not accessing the memory device by reference to the device selection signal; and
pausing the direct memory access operation when the direct memory access device finds that the processor is going to access the memory device by reference to the device selection signal.

12. The method of claim 11, further comprising:
providing a waiting queue for storing a plurality of direct memory operations issued by the processor.

13. The method of claim 12, further comprising:
moving the direct memory access operation into the waiting queue when the detection circuit detects the processor is going to access the memory device by detecting the device selection signal.

14. The method of claim 11 wherein the memory device is disposed in an integrated circuit chip and the device selection signal is a chip selection signal.

15. The method of claim 11, wherein the processor is a digital signal processor.

16. The method of claim 11, wherein the processor is a central processing unit (CPU).
